(19) United States
(12) Patent Application Publication
(10) Pub. No.: US 2016/0168418 A1
(43) Pub. Date: Jun. 16, 2016

(54) HEAT-CURABLE COMPOSITION

(71) Applicant: JNC CORPORATION, Toyyo (JP)

(72) Inventors: Yuki OKAMOTO, (US); Yuki Kimura, Chiba (JP); Tomohiro ETOU, Chiba (JP)

(21) Appl. No.: 14/436,650

(22) PCT Filed: Aug. 22, 2013
(86) PCT No.: PCT/JP2013/072422

§ 371 Date: Apr. 17, 2015

(30) Foreign Application Priority Data
Oct. 19, 2012 (JP) 2012-231588

(51) Int. Cl. C09D 183/04; C08G 77/00

(52) U.S. Cl. CPC C09D 183/04; C08G 77/80

(57) ABSTRACT

Provided are: a material which has high transparency and excellent sputtering resistance and heat resistance, does not undergo cracking, and can be formed into a cured film having a thickness of 10 to 200 μm by the application or printing of the material; and a cured film and a display element, each of which is produced using the material. Specifically, A heat-curable composition comprising a siloxane polymer and a solvent, wherein the siloxane polymer includes at least 90 wt %, based on the total amount of siloxane polymer, of a siloxane polymer (A) obtained by reacting a silane mixture containing a monofunctional silane of general formula (1) below and a trifunctional silane of general formula (2) below:

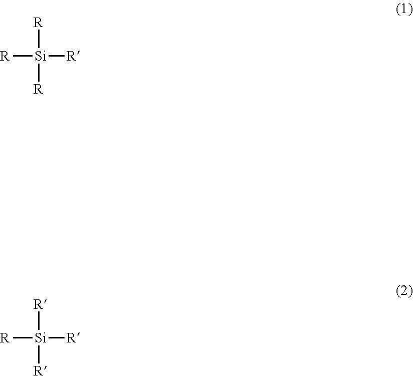

(wherein, in general formulas (1) and (2), R is independently hydrogen, an alkyl of 1 to 10 carbons in which any hydrogen may be substituted with a halogen, an aryl of 6 to 10 carbons in which any hydrogen may be substituted with a halogen, or an alkenyl of 2 to 10 carbons in which any hydrogen may be substituted with a halogen; and R′ is independently a hydrolyzable group), the trifunctional silane of general formula (2) including, in a proportion that is at least 30 mol % of the total amount of trifunctional silane, a trifunctional silane wherein R is an aryl of 6 to 10 carbons in which any hydrogen may be substituted with a halogen.

### TECHNICAL FIELD

The present invention relates to a heat-curable composition which can be used in cured films such as protective films.

### BACKGROUND ART

In the course of manufacture during the production of devices such as liquid-crystal display devices, there are cases in which the surface of the display device being processed is treated with various chemicals such as organic solvents, acids, and alkali solutions, or is locally heated to high temperatures when forming interconnects and electrodes as a film by sputtering. Hence, surface-protecting films are sometimes provided in order to prevent deterioration, damage or loss in quality of the surfaces of various types of devices. Such protective films are required to have properties that enable them to withstand various types of treatment in these manufacturing operations. Specific required properties include heat resistance, chemical resistance such as solvent resistance, acid resistance and alkali resistance, water resistance, ability to adhere to an underlying substrate such as glass, transparency, scuff resistance, coating properties, printability, planarity, and weather resistance that keeps a loss in quality such as discoloration from arising over a long period of time. Siloxane-based materials are known as materials for the formation of cured films having such properties (see, for example, Patent Documents 1 to 4).

In addition, in recent years, active research and development has been carried out on siloxane-based materials having new properties, such as a high heat resistance to temperatures of 200° C. and above and high transparency even at film thicknesses of 10 μm or more (thick films). The inventors earlier invented a material which has a high transparency and excellent heat resistance, which is not subject to cracking and which, when coated onto a surface, is capable of forming a cured film having a thickness of from 10 to 200 μm (Patent Document 5).

Siloxane polymer compositions obtained by the hydrolysis and condensation of a silane mixture containing a monofunctional silane and a trifunctional silane are known (Patent Document 6). However, although such siloxane polymer compositions themselves are known, the heat resistance, transparency and sputtering resistance when such compositions are rendered into cured films have not been mentioned in the literature and have hitherto been unknown.

Patent Document 1: Japanese Patent Application Laid-open No. H6-346025

Patent Document 2: Japanese Patent Application Laid-open No. 2000-303023

Patent Document 3: Japanese Patent Application Laid-open No. 2001-115026

Patent Document 4: Japanese Patent Application Laid-open No. 2003-031569

Patent Document 5: Japanese Patent Application Laid-open No. 2011-084639

Patent Document 6: Japanese Examined Patent Publication No. S49-45320

### DISCLOSURE OF THE INVENTION

It has been found that there remains room for improvement in the sputtering resistance of the heat-curable composition disclosed in Patent Document 5. Because the manufacture of devices such as liquid-crystal display devices sometimes includes a step in which interconnects and electrodes are formed as a film by sputtering, sputtering resistance can be regarded as an important property.

It is therefore an object of the invention to provide a material which, in addition to having a high transparency and heat resistance, has an excellent sputtering resistance, is not subject to cracking and, when coated onto a surface, is capable of forming a cured film having a thickness of from 10 to 200 μm.

The inventors have conducted extensive investigations aimed at overcoming the foregoing problem. As a result, they have discovered that a composition which contains a specific amount of a polymer made up of specific siloxane monomers is able to resolve this problem. That is, as a result of extensive research and development, the inventors have succeeded in developing a material which, in addition to the properties mentioned in Patent Document 5, also has sputtering resistance.

The invention is recited below.

[1] A heat-curable composition which includes a siloxane polymer and a solvent, wherein the siloxane polymer includes at least 90 wt %, based on the total amount of siloxane polymer, of a siloxane polymer (A) obtained by reacting a silane mixture containing a monofunctional silane of general formula (1) below and a trifunctional silane of general formula (2) below:

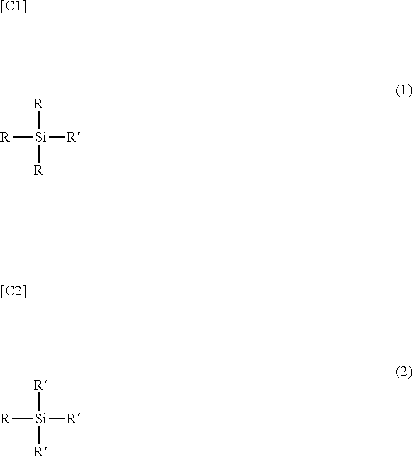

(wherein, in general formulas (1) and (2), R is independently hydrogen, an alkyl of 1 to 10 carbons in which any hydrogen may be substituted with a halogen, an aryl of 6 to 10 carbons in which any hydrogen may be substituted with a halogen, or an alkenyl of 2 to 10 carbons in which any hydrogen may be substituted with a halogen; and R′ is independently a hydrolyzable group), the trifunctional silane of general formula (2) including, in a proportion that is at least 30 mol % of the total amount of trifunctional silane, a trifunctional silane wherein R is an aryl of 6 to 10 carbons in which any hydrogen may be substituted with a halogen.

[2] The heat-curable composition of [1] wherein, in general formulas (1) and (2), R is independently hydrogen, an alkyl of 1 to 5 carbons in which any hydrogen may be substituted with a halogen, an aryl of 6 to 10 carbons in which any hydrogen may be substituted with a halogen, or an alkenyl of 2 to 10 carbons in which any hydrogen may be substituted with a halogen; and R′ is independently an alkoxy, a halogen or acetoxyl.

[3] The heat-curable composition of [1] or [2], wherein the monofunctional silane of general formula (1) is one or more selected from the group consisting of trimethylmethoxysilane and trimethylethoxysilane.

[4] The heat-curable composition of any one of [1] to [3], wherein the trifunctional silane of general formula (2) is a mixture of one or more selected from among trimethoxyphenylsilane and triethoxyphenylsilane with one or more selected from among trimethoxymethylsilane and triethoxymethylsilane.

[5] The heat-curable composition of any one of [1] to [4], wherein the monofunctional silane of general formula (1) is trimethylmethoxysilane and the trifunctional silane of general formula (2) is a mixture of trimethoxymethylsilane and trimethoxyphenylsilane.

[6] The heat-curable composition of [5], wherein the siloxane polymer (A) has a ratio of the number of methyl groups to the number of phenyl groups therein of from 1.0 to 3.0.

[7] A cured film having a thickness of from 10 to 200 μm obtained by heat-curing the heat-curable composition of any one of [1] to [6], at 200° C. or above.

[8] A display device having the cured film of [7].

It is possible to obtain from the heat-curable composition of the invention a cured film which not only has a high transparency and excellent heat resistance, but also has an excellent sputtering resistance. Even in cases where the cured film obtained from the inventive heat-curable composition is a thick film (having a film thickness of from 10 to 200 μm), cracks do not arise. The invention is also able to provide such a cured film and a display device which includes the same.

### MODE FOR CARRYING OUT THE INVENTION

1. Heat-Curable Composition of the Invention

The heat-curable composition of the invention contains a siloxane polymer and a solvent. The siloxane polymer includes at least 90 wt %, based on the total amount of siloxane polymer, of a Siloxane Polymer (A) obtained by reacting a silane mixture containing a monofunctional silane of general formula (1) below and a trifunctional silane of general formula (2) below. The heat-curable composition of the invention may additionally include ingredients other than Siloxane Polymer (A) and the solvent, so long as the advantageous effects of the invention can be obtained.

From the standpoint of setting the thickness of the cured film to at least 10 μm, the content of Siloxane Polymer (A) in the heat-curable composition of the invention, based on the total amount of the heat-curable composition, is preferably from 20 to 80 wt %, more preferably from 30 to 80 wt %, and even more preferably from 40 to 80 wt %.

1-1. Siloxane Polymer (A)

Siloxane Polymer (A) is obtained by reacting a silane mixture containing a monofunctional silane of general formula (1) and a trifunctional silane of general formula (2). From the standpoint of the sputtering resistance and the cracking resistance, the mixing proportions (molar ratio) of the monofunctional silane of general formula (1) and the trifunctional silane of general formula (2), expressed as the number of moles of the trifunctional silane of general formula (2) per mole of the monofunctional silane of general formula (1), is preferably from 1 to 20 moles, more preferably from 1 to 15 moles, and even more preferably from 1 to 10 moles.

1-2 Monofunctional Silane of General Formula (1)

In the monofunctional silane of general formula (1) below, R is independently hydrogen, an alkyl of 1 to 10 carbons in which any hydrogen may be substituted with halogen, an aryl of 6 to 10 carbons in which any hydrogen may be substituted with halogen, or an alkenyl of 2 to 10 carbons in which any hydrogen may be substituted with halogen; and R′ is independently a hydrolyzable group.

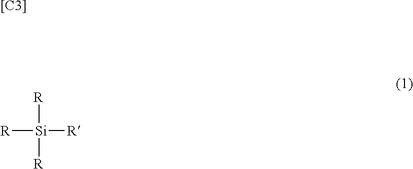

In formula (1), it is preferable for R to be independently hydrogen, an alkyl of 1 to 5 carbons in which any hydrogen may be substituted with a halogen, an aryl of 6 to 10 carbons in which any hydrogen may be substituted with a halogen, or an alkenyl of 2 to 10 carbons in which any hydrogen may be substituted with a halogen; and for R′ to be independently an alkoxy, a halogen or acetoxyl. The halogen is preferably chlorine or fluorine.

It is more preferable for R to be independently methyl, ethyl or phenyl; and for R′ to be independently methoxy or ethoxy.

The monofunctional silane of general formula (1) is exemplified by trimethylmethoxysilane and trimethylethoxysilane. These monofunctional silanes are preferred from the standpoint of functioning to control the molecular weight of the resulting heat-curable composition.

1-3. Trifunctional Silane of General Formula (2)

In the trifunctional silane of general formula (2) below, R is independently hydrogen, an alkyl of 1 to 10 carbons in which any hydrogen may be substituted with a halogen, an aryl of 6 to 10 carbons in which any hydrogen may be substituted with a halogen, or an alkenyl of 2 to 10 carbons in which any hydrogen may be substituted with a halogen; and R′ is independently a hydrolyzable group.

Of the trifunctional silane of general formula (2), the proportion of trifunctional silane wherein R is an aryl of 6 to 10 carbons in which any hydrogen may be substituted with a halogen is at least 30 mol % of the total amount of trifunctional silane.

The proportion of trifunctional silane in which R is this specific aryl is more preferably at least 40 mol %, and even more preferably at least 45 mol %, of the total amount of trifunctional silane.

The proportion of this trifunctional silane in which R is this specific aryl is preferably not more than 70 mol %, more preferably not more than 60 mol %, and even more preferably not more than 55 mol %, of the total amount of trifunctional silane.

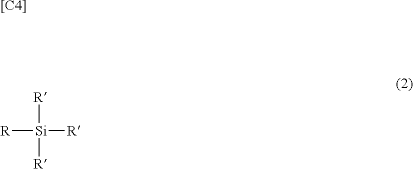

In formula (2), it is preferable for R to be independently hydrogen, an alkyl of 1 to 5 carbons in which any hydrogen may be substituted with a halogen, an aryl of 6 to 10 carbons in which any hydrogen may be substituted with a halogen, or an alkenyl of 2 to 10 carbons in which any hydrogen may be substituted with a halogen; and for R′ to be independently an alkoxy, a halogen or acetoxyl. The halogen is preferably chlorine or fluorine.

It is more preferable for R to be independently methyl, ethyl or phenyl; and for R′ to be independently methoxy or ethoxy.

Here, from the standpoint of cracking resistance, it is preferable to use as the trifunctional silane of general formula (2): a mixture of a compound in which R is an unsubstituted alkyl of 1 to 5 carbons and a compound in which R is an unsubstituted aryl of 6 to 10 carbons. The mixing proportions (molar ratio) of the compound in which R is an unsubstituted alkyl of 1 to 5 carbons and the compound in which R is an unsubstituted aryl of 6 to 10 carbons are preferably from 0.1 to 10 moles, more preferably from 0.2 to 5 moles, and even more preferably from 0.3 to 3 moles, of the compound in which R is an unsubstituted aryl of 6 to 10 carbons per mole of the compound in which R is an unsubstituted alkyl of 1 to 5 carbons.

At this time, the alkyl is preferably methyl or ethyl, and the aryl is more preferably phenyl.

Illustrative examples of such trifunctional silanes of general formula (2) include trimethoxymethylsilane, trimethoxyphenylsilane, triethoxymethylsilane and triethoxyphenylsilane.

These trifunctional silanes are preferred from the standpoint of enhancing the denseness of the cured film to be formed from the resulting heat-curable composition.

Regarding the trifunctional silane of general formula (2), in order for the proportion of trifunctional silane having the above specific aryl as R to satisfy the above specific proportion with respect to the total amount of trifunctional silane, it is preferable to include one or more trifunctional silane selected from among trimethoxyphenylsilane and triethoxyphenylsilane.

The content of the one or more trifunctional silane selected from among trimethoxyphenylsilane and triethoxyphenylsilane is preferably at least. 30 mol %, more preferably at least 40 mol %, and even more preferably at least 45 mol %, of the total amount of trifunctional silane.

The content of the at least one trifunctional silane selected from among trimethoxyphenylsilane and triethoxyphenylsilane is preferably not more than 70 mol %, more preferably not more than 60 mol %, and most preferably not more than 55 mol %, of the total amount of trifunctional silane.

The trifunctional silane of general formula (2) which does not have the above specific aryl as R is preferably one or more selected from among trimethoxymethylsilane and triethoxymethylsilane.

As mentioned above, Siloxane Polymer (A) is obtained by reacting a silane mixture containing a monofunctional silane of general formula (1) and a trifunctional silane of general formula (2).

In cases where both methyl and phenyl from R in the monofunctional silane of general formula (1) and R in the trifunctional silane of general formula (2) are included in the Siloxane Polymer (A), the ratio of the number of methyl groups to the number of phenyl groups in the Siloxane Polymer (A) that has been produced is preferably from 1.0 to 3.0, and more preferably from 1.0 to 2.5.

By having the ratio of the number of methyls to the number of phenyls be 1.0 or more, the heat-curable composition can be assured of having a high heat resistance (30 minutes at 250° C.). And by having the ratio of the number of methyls to the number of phenyls be 3.0 or less, gelation of the siloxane polymer can be prevented.

The methyl groups and phenyl groups together account for a proportion of the overall number of R groups on the monofunctional silane of general formula (1) and the trifunctional silane of general formula (2) which is preferably at least 50%, more preferably at least 80%, and even more preferably 100%.

Illustrative examples of R groups other than methyl and phenyl include ethyl, propyl, butyl, cyclopentane and cyclohexyl.

The ratio of the number of methyl groups to the number of phenyl groups in Siloxane Polymer (A) can be measured using, for example, nuclear magnetic resonance (NMR).

1-4. Other Silane Compounds

The silane mixture serving as the starting material for Siloxane Polymer (A) may include other silanes, provided doing so does not detract from the advantageous effects of the invention.

Silanes other than the monofunctional silane of general formula (1) and the trifunctional silane of general formula (2) which may be included in the silane mixture serving as the starting material for Siloxane Polymer (A) are exemplified by conventional silane compounds. When such conventional silane compounds are included, the content of conventional silane compounds within the silane mixture serving as the starting material for Siloxane Polymer (A) is generally from 1 to 10 wt %.

1-5. Method of Preparing Siloxane Polymer (A)

Siloxane Polymer (A) is obtained by reacting the monofunctional silane of general formula (1) with the trifunctional silane of general formula (2). The term “reaction” used here includes carrying out hydrolysis and condensation as described below. The reaction method for obtaining Siloxane Polymer (A) is not particularly limited, although production is possible by hydrolyzing and condensing the above silanes. Water and an acid catalyst or a basic catalyst may be used for hydrolysis. Illustrative examples of acid catalysts include formic acid, acetic acid, trifluoroacetic acid, nitric acid, sulfuric acid, hydrochloric acid, hydrofluoric acid, boric acid, phosphoric acid and cation exchange resins. Illustrative examples of basic catalysts include ammonia, triethylamine, monoethanolamine, diethanolamine, triethanolamine, sodium hydroxide, sodium carbonate, sodium bicarbonate, potassium hydroxide and anionic exchange resins. The reaction temperature is not particularly limited, but is generally in the range of 50° C. 150° C. The reaction time also is not particularly limited, but is generally in the range of 1 to 48 hours. This reaction may be carried out under any of the following pressure conditions: applied pressure, reduced pressure or atmospheric pressure. Following the reaction, in order to stabilize Siloxane Polymer (A), it is preferable to remove low-molecular-weight ingredients by distillation. Distillation may be carried out either at reduced pressure or normal pressure; at normal pressure, the distillation temperature is generally from about 100° C. to about 200° C.

The solvent used in the reaction is preferably a solvent that dissolves the silanes and the Siloxane Polymer (A) produced. The solvent may be a single solvent used alone or may be a mixture of two or more solvents (a mixed solvent). Illustrative examples of such solvents include methanol, ethanol, 1-propanol, 2-propanol, 1-butanol, 2-butanol, isobutanol, tert-butanol, acetone, 2-butanone, ethyl acetate, propyl acetate, butyl acetate, tetrahydrofuran, acetonitrile, dioxane, toluene, xylene, cyclopentanone, cyclohexanone, ethylene glycol monoethyl ether, propylene glycol monomethyl ether, propylene glycol monomethyl ether acetate, diethylene glycol dimethyl ether, diethylene glycol methyl ethyl ether, methyl 3-methoxypropionate and ethyl 3-ethoxypropionate.

To increase the heat resistance and solvent resistance of the cured film obtained from the resulting heat-curable composition, it is preferable for the siloxane polymer (A) to have a weight-average molecular weight, as determined by gel permeation chromatography (GPC) against a polystyrene standard, in the range of 1,000 to 100,000. To enhance compatibility with other ingredients, suppress whitening of the cured film formed from the resulting heat-curable composition and minimize roughness of the film surface, the weight-average molecular weight is more preferably in the range of 1,500 to 80,000. For similar reasons, the weight-average molecular weight is even more preferably in the range of 2,000 to 50,000.

In the practice of the invention, the weight-average molecular weight can be measured by GPC using polystyrene having a weight-average molecular weight of from 645 to 132,900 (e.g., the PL2010-0102 polystyrene calibration kit from VARIAN) as the polystyrene standard, using a PLgel MIXED-D column (from VARIAN) as the column and using tetrahydrofuran as the mobile phase.

1-6. Solvent

The solvent used in the invention may be a mixed solvent containing at least 20 wt % of a solvent having a boiling point of 100 to 300° C. One, two or more known solvents may be used as the solvents other than the solvent boiling at 100 to 300° C. within the mixed solvent. The solvent content, based on the total amount of the heat-curable composition, is preferably from 20 to 80 wt %, more preferably from 20 to 70 wt, and even more preferably from 20 to 50 wt %.

Using at least one from among propylene glycol monomethyl ether, propylene glycol monomethyl ether acetate, propylene glycol monoethyl ether acetate, methyl 3-methoxypropionate, ethyl 3-ethoxypropionate, diethylene glycol monoethyl ether acetate, diethylene glycol monobutyl ether acetate, diethylene glycol dimethyl ether, diethylene glycol methyl ethyl ether, ethyl lactate and butyl acetate as the solvent in this invention is more preferred because doing so increases the coating uniformity (coating unevenness and pinholes in the cured film decrease).

1-7. Other Ingredients

Ingredients other than Siloxane Polymer (A) and the solvent may also be included in the heat-curable composition of the invention. Illustrative examples of such other ingredients include siloxane polymers other than Siloxane Polymer (A), surfactants, epoxy resins, epoxy curing agents, thermal crosslinking agents such as melamine compounds and bisazide compounds, antioxidants, acrylic-type, styrene-type, polyethyleneimine-type and urethane-type polymer dispersants, adhesion-enhancing agents such as silane coupling agents, and ultraviolet absorbers such as alkoxybenzophenones. One, two or more of these other ingredients overall may be added, or one, two or more of each type may be added.

1-7-1. Other Siloxane Polymers

The heat-curable composition of the invention may also include another siloxane polymer in order to enhance various performance attributes. Conventional siloxane polymers may be used as such other siloxane polymers in a conventional content range that does not detract from the advantageous effects of the invention. Of the siloxane polymers included in the heat-curable composition of the invention, the proportion accounted for by Siloxane Polymer (A) is at least 90 wt %, preferably at least 95 wt, and more preferably at least 99 wt %.

To improve the cracking resistance, it is preferable not to add to the heat-curable composition of the invention a siloxane polymer obtained by the reaction (hydrolysis and condensation) of a bifunctional silane of formula (3) below with a tetrafunctional silane of formula (4) below.

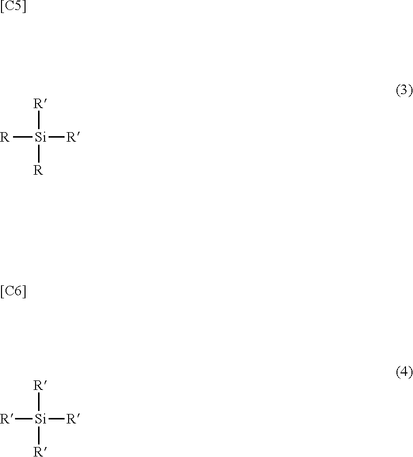

In formulas (3) and (4), R is independently hydrogen, an

alkyl of 1 to 10 carbons in which any hydrogen may be substituted with a halogen, an aryl of 6 to 10 carbons in which any hydrogen may be substituted with a halogen, or an alkenyl of 2 to 10 carbons in which any hydrogen may be substituted with a

halogen; and R′ is independently a hydrolyzable group.

1-7-2. Surfactant

To further enhance the coating uniformity and, where film formation is carried out by a printing method, the leveling properties after printing, the heat-curable composition of the invention may additionally include a surfactant. From this standpoint, when a surfactant is included, the content thereof, relative to the total amount of the heat-curable composition, is preferably from 0.01 to 10 wt %, more preferably from 0.05 to 8 wt %, and even more preferably from 0.1 to 5 wt %.

Illustrative examples of such surfactants include Polyflow No. 45, Polyflow KL-245, Polyflow No. 75, Polyflow No. 90 and Polyflow No. 95 (all available under these trade names from Kyoeisha Chemical Co., Ltd.), Disperbyk 161, Disperbyk 162, Disperbyk 163, Disperbyk 164, Disperbyk 166, Disperbyk 170, Disperbyk 180, Disperbyk 181, Disperbyk 182, BYK 300, BYK 306, BYK 310, BYK 320, BYK 330, BYK 342 and BYK 346 (all available under these trade names from BYK Japan KK), KP-341, KP-358, KP-368, KF-96-50CS and KF-50-100CS (all available under these trade names from Shin-Etsu Chemical Co., Ltd.), Surflon SC-101 and Surflon KH-40 (both available under these trade names from AGC Seimi Chemical Co., Ltd.), Futergent 222F, Futergent 251 and FTX-218 (all available under these trade names from Neos Co., Ltd.), EFTOP EF-351, EFTOP EF-352, EFTOP EF-601, EFTOP EF-801 and EFTOP EF-802 (all available under these trade names from Mitsubishi Materials Electronic Chemicals Co., Ltd.), Megafac F-171, Megafac F-177, Megafac F-475, Megafac F-477, Megafac R-08 and Megafac R-30 (all available under these trade names from DIC Corporation), fluoroalkylbenzenesulfonic acid salts, fluoroalkylcarboxylic acid salts, fluoroalkyl polyoxyethylene ethers, fluoroalkylammonium iodides, fluoroalkylbetaines, fluoroalkylsulfonic acid salts, diglycerol tetrakis(fluoroalkyl polyoxyethylene ethers), fluoroalkyl trimethylammonium salts, fluoroalkyl aminosulfonic acid salts, polyoxyethylene nonyl phenyl ether, polyoxyethylene octyl phenyl ether, polyoxyethylene alkyl ethers, polyoxyethylene lauryl ether, polyoxyethylene oleyl ether, polyoxyethylene tridecyl ether, polyoxyethylene cetyl ether, polyoxyethylene stearyl ether, polyoxyethylene laurate, polyoxyethylene oleate, polyoxyethylene stearate, polyoxyethylene laurylamine, sorbitan laurate, sorbitan palmitate, sorbitan stearate, sorbitan oleate, sorbitan fatty acid esters, polyoxyethylene sorbitan laurate, polyoxyethylene sorbitan palmitate, polyoxyethylene sorbitan stearate, polyoxyethylene sorbitan oleate, polyoxyethylene naphthyl ether, alkylbenzenesulfonic acid salts and alkyldiphenyl ether disulfonic acid salts.

Of these, commercially available surfactants and fluorine surfactants such as fluoroalkylbenzenesulfonic acid salts, fluoroalkylcarboxylic acid salts, fluoroalkyl polyoxyethylene ethers, fluoroalkylammonium iodides, fluoroalkylbetaines, fluoroalkylsulfonic acid salts, diglycerol tetrakis(fluoroalkyl polyoxyethylene ethers), fluoroalkyltrimethylammonium salts and fluoroalkylaminosulfonic acid salts are preferred for increasing the coating uniformity of the heat-curable composition and, in cases where film formation is carried out by a printing method, for increasing the leveling properties after printing.

1-7-3. Epoxy Resins

The heat-curable composition of the invention may additionally include an epoxy resin in order to further enhance the heat resistance, chemical resistance, film in-plane uniformity, pliability, flexibility and elasticity.

From the standpoint of obtaining a cured film having a high chemical resistance, the epoxy resin is preferably a polyfunctional epoxy resin. Illustrative examples of such polyfunctional epoxy resins include bisphenol A-type epoxy resins, glycidyl ester-type epoxy resins and alicyclic epoxy resins. Illustrative examples of these epoxy resins include Epikote 807, Epikote 815, Epikote 825, Epikote 827, Epikote 828, Epikote 190P and Epikote 191P (available under this trade name from Yuka-Shell Epoxy KK), Epikote 1004, Epikote 1256 and YX8000 (available under these trade names from Mitsubishi Chemical Corporation), Araldite CY177 and Araldite CY184 (available under these trade names from Nihon Ciba-Geigy KK), Celloxide 2021P and EHPE-3150 (available under these trade names from Daicel Corporation), and Techmore VG3101L (available under this trade name from Printec Corporation.).

Also, to enhance such properties as pliability, flexibility and elasticity, an epoxy resin may be added to the heat-curable composition. From this standpoint, the epoxy resin content is preferably not more than 30 wt %, based on the total amount of the heat-curable composition.

Illustrative examples of the epoxy resin added for this purpose include Epikote 871, Epikote 872, Epikote 4250 and Epikote 4275 (available under these trade names from Mitsubishi Chemical Corporation), EPICLON TSR-960, EPICLON TSR-601, EPICLON TSR-250-80BX and EPICLON 1600-75X (available under these trade names from DIC Corporation), YD-171, YD-172, YD-175X75, PG-207, ZX-1627 and YD-716 (available under these trade names from Tohto Kasei Co., Ltd.), Adeka Resin EP-4000, Adeka Resin EP-4000S, Adeka Resin EPB1200 and Adeka Resin EPB1200 (available under these trade names from Adeka Corporation), EX-832, EX-841, EX-931 and Denarex R-45EPT (available under these trade names from Nagase Chemtex Corporation), BPO-20E and BPO-60E (available under these trade names from New Japan Chemical Co., Ltd.), Epolite 400E, Epolite 400P and Epolite 3002 (available under these trade names from Kyoeisha Chemical Co., Ltd.), SR-8EG and SR-4PG (available under these trade names from Sakamoto Yakuhin Kogyo Co., Ltd.), Heloxy 84 and Heloxy 505 (available under these trade names from Hexion KK), SB-20G and IPU-22G (available under these trade names from Okamura Oil Mill Co., Ltd.), Epolead PB3600 (available under this trade name from Daicel Corporation) and EPB-13 (available under this trade name from Nippon Soda Co., Ltd.).

1-7-4. Epoxy Curing Agents

In cases where an epoxy resin is included as another ingredient in the heat-curable composition of the invention, it is preferable for the composition to include also an epoxy curing agent in order to enhance the heat resistance, chemical resistance, pliability and flexibility of the cured film. Exemplary epoxy curing agents include carboxylic acid-type curing agents, acid anhydride-type curing agents, amine-type curing agents, phenol-type curing agents and catalyst-type curing agents. To suppress discoloration and heat resistance, it is more preferable for the epoxy curing agent to be a carboxylic acid-type curing agent, an acid anhydride-type curing agent or a phenol-type curing agent.

Preferred examples of epoxy curing agents include carboxylic-type curing agents such as SMA17352 (available under this trade name from Sartomer Japan Ink), and acid anhydride-type curing agents such as SMA1000, SMA2000 and SMA3000 (available under these trade names from Sartomer Japan Ink), maleic anhydride, tetrahydrophthalic anhydride, hexahydrophthalic acid, methyltetrahydrophthalic anhydride, methylhexahydrophthalic acid anhydride, phthalic anhydride, tetrahydrophthalic anhydride, methyltetrahydrophthalic anhydride, trimellitic anhydride, hexahydrotrimellitic anhydride, methylnadic anhydride, hydrogenated methylnadic anhydride, dodecenylsuccinic anhydride, pyromellitic dianhydride, hexahydropyromellitic dianhydride, benzophenonetetracarboxylic dianhydride, TMEG, TMTA-C, TMEG-500 and TMEG-600 (available under these trade names from New Japan Chemical Co., Ltd.), Epiclon B-4400 (available under this trade name from DIC Corporation), YH-306, YH-307 and YH-309 (available under these trade names from Mitsubishi Chemical Corporation), SL-12AH, SL-20AH and IPU-22AH (available under these trade names from Okamura Oil Mill Co., Ltd.), and OSA-DA, DSA and PDSA-DA (available under these trade names from Sanyo Chemical Industries, Ltd.).

Preferred examples of phenol-type curing agents include hydroquinone, catechol, resorcinol, fluoroglucinol, pyrogallol, 1,6-dihydroxynaphthalene, 2,7-dihydroxynaphthalene, 2,6-dihydroxynaphthalene, 1,2,4-trihydroxybenzene, 1,3-dihydroxynaphthalene, 1,4-dihydroxynaphthalene, 1,5-dihydroxynaphthalene, 1,7-dihydroxynaphthalene, 2,3-dihydroxynaphthalene, 1,2-dihydroxynapthalene, methylresorcinol, 5-methylresorcinol, hexahydroxybenzene, 1,8,9-trihydroxyanthracene, 3-methylcatechol, methylhydroquinone, 4-methylcatechol, 4-benzylresorcinol, 1,1′-bi-2-naphthol, 4,4′-biphenol, bis(4-hydroxyphenyl)sulfone and 4-bromoresorcinol.

Additional preferred examples of phenol-type curing agents include 4,4′-butylidenebis(6-tert-butyl-m-cresol), 4-tert-butylpyrocatechol, 2,2′-biphenol, 4,4′-dihydroxydiphenylmethane, tert-butylhydroquinone, 1,3-bis(4-hydroxyphenoxy)benzene, 1,4-bis(3-hydroxyphenoxy)benzene, 1,1-bis(4-hydroxyphenyl)cyclohexane, bis(4-hydroxy-3,5-dimethylphenyl)sulfone, 9,9-bis(4-hydroxyphenyl)fluorene, 9,9-bis(4-hydroxy-3-methylphenyl)fluorene, 4-tert-butylcalix[8]arene, 4-tert-butylcalix[5]arene, 4-tert-butylsulfonylcalix[4]arene, calyx[8]arene, calyx[4]arene, calyx[6]arene and 4-tert-butylcalix[6] arene.

Preferred examples of phenol-type curing agents also include 2,5-bis(1,1,3,3-tetramethylbutyl)hydroquinone, bis[(2-hydroxy-5-methylphenyl)methyl]-4-methylphenol, 1,1-bis(3-cyclohexyl-4-hydroxyphenyl)cyclohexane, 1,1-bis(4-hydroxy-3-methylphenyl)cyclohexane, hexestrol, 2′,4′-dihydroxyacetophenone, anthrarufin, chrysazin, 2,4-dihydroxybenzaldehyde, 2,5-dihydroxybenzaldehyde, 3,4-dihydroxybenzaldehyde, ethyl 3,4-dihydroxybenzoate, 2,4-dihydroxybenzophenone, 2,2′-dihydroxy-4,4′-dimethoxybenzophenone, 4,4′-dihydroxybenzophenone, 4-ethylresorcinol and phenylhydroquinone.

Preferred examples of phenol-type curing agents also include 2,2′-dihydroxy-4-methoxybenzophenone, 2,2′-dihydroxybenzophenone, methyl 2,6-dihydroxybenzoate, 2,3-dihydroxybenzaldehyde, octafluoro-4,4′-biphenol, 3′,6′-dihydroxybenzonorbornene, 2,4′-dihydroxydiphenylmethane, 2′,5′-dihydroxyacetophenone, 3′,5′-dihydroxyacetophenone, 2,4-dihydroxybenzoic acid, 2-hydroxyethyl 4,4′-dihydroxydiphenyl ether, 2,2′-dihydroxydiphenyl ether, methyl 3,5-dihydroxybenzoate, phenyl 1,4-dihydroxy-2-naphthoate, 3′,4′-dihydroxyacetophenone, 2,4′-dihydroxydiphenylsulfone, 3,4-dihydroxybenzyl alcohol and 3,5-dihydroxybenzyl alcohol.

Preferred examples of phenol-type curing agents also include 2,4′-dihydroxybenzophenone, 2,6-dimethylhydroquinone, daidzein, 2′,4′-dihydroxypropiophenone, 4,4′-dihydroxytetraphenylmethane, methyl 3,4-dihydroxyphenylacetate, 2,5-dimethylresorcinol, 2-(3,4-dihydroxyphenyl)ethyl alcohol, 4,4′-ethylidene bisphenol, 3,3′-ethylene dioxydiphenol, 4-fluorocatechol, ethyl gallate, methyl gallate, propyl gallate, isoamyl gallate, hexadecyl gallate, dodecyl gallate, stearyl gallate, butyl gallate, isobutyl gallate, n-octyl gallate-4-hexylresorcinol.

Preferred examples of phenol-type curing agents also include 4,4′-(2-hydroxybenzylidene)bis(2,3,6-trimethylphenol), 4,4′-methylenebis(2,6-di-tert-butylphenol), 2,2′-methylenebis(6-tert-butyl-4-ethylphenol), 2,2′-methylenebis(6-tert-butyl-p-cresol), methoxyhydroquinone, 4,4′-(α-methylbenzylidene)bisphenol, 4,4′-methylenebis(2,6-dimethylphenol, 2,2′-methylenebis(4-methylphenyl), 5-methoxyresorcinol, 2,2′-methylenebis[6-(2-hydroxy-5-methylbenzyl)-p-cresol], 4,4′-methylenebis(2-methylphenol), methyl 2,4-dihydroxybenzoate, 2,2′-methylenebis(6-cyclohexyl-p-cresol), methyl 3,4-dihydroxybenzoate and methyl 2,5-dihydroxybenzoate.

Preferred examples of phenol-type curing agents also include naringenin, leucoquinizarin, 2,2′-,4,4′-tetrahydroxybenzophenone, 2,4,4′-trihydroxybenzophenone, 5-methylpyrogallol, 2′,4′,6′-trihydroxypropiophenone, 2,3,4-trihydroxybenzophenone, 2′,3′,4′-trihydroxyacetophenone, 1,1,1-tris(4-hydroxyphenyl)ethane, 2′,3,4,4′-tetrahydroxybenzophenone, 4,4′,4″-trihydroxytriphenylmethane, 2,3,4,4′-tetrahydroxybenzophenone, 2,3,4,4′-tetrahydroxydiphenylmethane, 5,5′,6,6′-tetrahydroxy-3,3,3′,3′-tetramethyl-1,1′-spirobiindane, 2,4,5-trihydroxybenzaldehyde, 6,6′,7,7′-tetrahydroxy-4,4,4′,4′-tetramethylspirobichromane and tetrafluorohydroquinone.

Preferred examples of phenol-type curing agents also include 2,3,4-trihydroxybenzaldehyde, 2,2-bis(4-hydroxyphenyl)propane, 2,2-bis(4-hydroxyphenyl)hexafluoropropane, 2,2-bis(2-hydroxy-5-biphenylyl)propane, 2,2-bis(3-cyclohexyl-4-hydroxyphenyl)propane, 2,2-bis(3-sec-butyl-4-hydroxyphenyl)propane, 2,2-bis(4-hydroxy-3,5-dimethylphenyl)propane, 2,2-bis(4-hydroxy-3-isopropylphenyl)propane, 2,2-bis(4-hydroxy-3-methylphenyl)propane, 2,2-bis(4-hydroxyphenyl)butane, α,α′-bis(4-hydroxy-3,5-dimethylphenyl)-1,4-diisopropylbenzene, α,α′-bis(4-hydroxyphenyl)-1,4-diisopropylbenzene, α,α,α′-tris(4-hydroxyphenyl)-1-ethyl-4-isopropylbenzene, tetrabromobisphenol A, 1,3-bis[2-(4-hydroxyphenyl)-2-propyl]benzene and α,α-bis(4-hydroxyphenyl)-4-(4-hydroxy-α,α-dimethylbenzyl)ethylbenzene.

Preferred examples of phenol-type curing agents also include Maruka Lyncur M (available under this trade name from Maruzen Petrochemical Co., Ltd.), Milex WLC (available under this trade name from Mitsui Chemicals, Inc.), MEH-7800, MEP-6309, MEH-7500, MEH-8000H and MEH-8005 (available under these trade names from Meiwa Plastic Industries, Ltd.), HE-100C (available under this trade name from Air Water Inc.), YLH-129B65, 170, 171N and YL-6065 (available under these trade names from Mitsubishi Chemical Corporation), the Phenolite VH series, the Phenolite KH series and BESMOL CZ-256-A (available under these trade names from DIC Corporation), and the DPP-6000 series (available under this trade name from Nippon Oil Corporation).

Having the content of the epoxy curing agent, based on the total amount of the heat-curable composition, be 5 wt % or more is preferable for enhancing the heat resistance and solvent resistance. To achieve a good balance with other properties, this content is more preferably from 5 to 50 wt %.

1-7-5. Thermal Crosslinking Agent

To further improve the heat resistance and the chemical resistance, the heat-curable composition of the invention may additionally include a thermal crosslinking agent such as a melamine compound or a bisazide compound. From this perspective, the content of the thermal crosslinking agent, based on the total amount of the heat-curable composition, is preferably from 0.1 to 30 wt %, more preferably from 0.05 to 20 wt %, and even more preferably from 1 to 10 wt %.

Illustrative examples of such thermal crosslinking agents include Nikalac MW-30HM, Nikalac MW-100LM, Nikalac MW-270, Nikalac MW-280, Nikalac MW-290, Nikalac MW-390 and Nikalac MW-750LM (available under these trade names from Sanwa Chemical Co., Ltd.). Of these, Nikalac MW-30HM is preferred from the standpoint of heat resistance and solvent resistance.

1-7-6. Antioxidant

The heat-curable composition of the invention may additionally include an antioxidant for weather resistance. From such a perspective, the content of the antioxidant, based on the total amount of the heat-curable composition, is preferably from 0.01 to 10 wt %, more preferably from 0.05 to 8 wt %, and even more preferably from 0.1 to 5 wt %. Exemplary antioxidants include hindered phenol-type antioxidants, hindered amine-type antioxidants, phosphorus-containing antioxidants, and sulfur-containing antioxidants. Of these, hindered phenol-type antioxidants are more preferred.

Illustrative examples of antioxidants include Irganox FF, Irganox 1035, Irganox 1035FF, Irganox 1076, Irganox 1076FD, Irganox 1076DWJ, Irganox 1098, Irganox 1135, Irganox 1330, Irganox 1726, Irganox 1425 WL, Irganox 1520L, Irganox 245, Irganox 245FF, Irganox 245DWJ, Irganox 259, Irganox 3114, Irganox 565, Irganox 565DD and Irganox 295 (available under these trade names from BASF Japan Ltd.), ADK Stab AO-20, ADK Stab AO-30, ADK Stab AO-50, ADK Stab AO-60, ADK Stab AO-70 and ADK Stab AO-80 (available under these trade names from Adeka Corporation). Of these, ADK Stab AO-60 is more preferred from the standpoint of transparency, heat resistance and cracking resistance.

1-7-7. Polymer Dispersant

The heat-curable composition of the invention may also include a polymer dispersant in order to further enhance the coating uniformity. From this standpoint, the content of the polymer dispersant, based on the total amount of the heat-curable composition, is preferably from 0.01 to 10 wt %, more preferably from 0.05 to 8 wt %, and even more preferably from 0.1 to 5 wt %.

Illustrative examples of such polymer dispersants include SOLSPERSE 3000, SOLSPERSE 5000, SOLSPERSE 12000, SOLSPERSE 20000 and SOLSPERSE 32000 (all available under these trade names from The Lubrizol Corporation), and Polyflow No. 38, Polyflow No. 45, Polyflow No. 75, Polyflow No. 85, Polyflow No. 90, Polyflow S, Polyflow No. 95, Polyflow ATF and Polyflow KL-245 (all available under these trade names from Kyoeisha Chemical Co., Ltd.).

1-7-8. Adhesion-Enhancing Agent

The heat-curable composition of the invention may also include an adhesion-enhancing agent so as to further enhance adhesion between the cured film to be formed and the substrate. To this end, the content of the adhesion-enhancing agent, based on the total amount of the heat-curable composition, is preferably not more than 10 wt %. At the same time, when the heat-curable composition includes an adhesion-enhancing agent, the content of the adhesion-enhancing agent, based on the overall composition, is preferably at least 0.5 wt %.

A silane-type coupling agent, an aluminum-containing coupling agent or a titanate-type coupling agent may be used as the adhesion-enhancing agent. Illustrative examples include silane-type coupling agents such as 3-glycidoxypropyldimethylethoxysilane, 3-glycidoxypropylmethyldiethoxysilane and 3-glycidoxypropyltrimethoxysilane, aluminum-containing coupling agents such as acetalkoxyaluminum diisopropylate, and titanate-type coupling agents such as tetraisopropylbis(dioctylphosphite)titanate.

Of these, 3-glycidoxypropyltrimethoxysilane is preferred because it has a large adhesion-enhancing effect.

1-7-9. Ultraviolet Absorber

The heat-curable composition of the invention may also include an ultraviolet absorber in order to further enhance the deterioration-preventing ability of the cured film. From this standpoint, the content of the ultraviolet absorber, based on the total amount of the heat-curable composition, is preferably from 0.01 to 10 wt %, more preferably from 0.05 to 8 wt %, and even more preferably from 0.1 to 5 wt %.

Illustrative examples of such ultraviolet absorbers include Tinuvin P, Tinuvin 120, Tinuvin 144, Tinuvin 213, Tinuvin 234, Tinuvin 326, Tinuvin 571 and Tinuvin 765 (all available under these trade names from BASF Japan Ltd.). Of these, Tinuvin P, Tinuvin 120 and Tinuvin 326 are preferred from the standpoint of transparency and compatibility.

1-8. Storage of Heat-Curable Composition

When the heat-curable composition of the invention is stored at a temperature in the range of −30° C. to 25° C., the composition has a good stability over time, which is desirable. Storage at a temperature of from −20° C. to 10° C. is more preferred′ because no precipitates form.

1-9. Preparation of Coating Solution

Depending on the thickness of the cured film to be formed and the coating method that is selected, a coating solution may be prepared by further diluting the heat-curable composition of the invention with a solvent.

2. Cured Film of the Invention

The cured film of the invention is obtained by using heat to cure the applied film formed from the above-described heat-curable composition of the invention. The applied film can be formed by coating the heat-curable composition of the invention onto the substrate. As the substrate and the coating method, the commonly used substrate and technique for display devices can be used, respectively.

The cured film of the invention, even at a thickness of 10 μm or more, has useful effects which include not only a high transparency and an excellent heat resistance, but also an excellent sputtering resistance and resistance to crack formation.

The thickness of the cured film can be measured using an ordinary device and method; a value representing the thickness of the cured film may be employed. For example, the average of the thicknesses measured at a plurality of places on the same film may be treated as the thickness of the cured film. From the standpoint of achieving a sufficient mechanical strength, the thickness of the cured film is preferably at least 10 μm, more preferably at least 15 μm, and even more preferably at least 20 μm. Within this range, the useful effects described above are clearly manifested. To achieve a sufficient transparency and prevent the formation of cracks, the thickness of the cured film is preferably not more than 200 μm, more preferably not more than 150 μm, and even more preferably not more than 100 μm.

The thickness of the cured film can be controlled by adjusting the thickness of the applied film that is formed using the heat-curable composition. The thickness of the film formed using the heat-curable composition can be controlled by adjusting the viscosity of the heat-curable composition or by repeated application of the heat-curable composition. The viscosity of the heat-curable composition can be controlled by adjusting the concentration of solids (primarily ingredients other than the solvent, such as Siloxane Polymer (A)).

The cured film of the invention may be formed as follows.

First, the heat-curable composition is coated or printed onto a substrate of glass or the like by a known coating method such as spin coating, roll coating or slit coating, or by a known printing method such as flexo printing, offset printing, gravure printing, screen printing or inkjet printing. From the standpoint of setting the film thickness to at least 10 μm, the film formation by screen printing is preferable.

Illustrative examples of substrates include clear glass substrates such as colorless flat glass, colored flat glass and silica-coated colored flat glass; sheets, films or substrates made of a synthetic resin such as polycarbonate, polyethersulfone, polyester, acrylic resin, polyvinyl chloride resin, aromatic polyamide resin, polyamideimide or polyimide; metal substrates such as aluminum plate, copper plate, nickel plate or stainless steel plate; and also ceramic plates, and semiconductor substrates containing photoelectric conversion elements. Where, desired, these substrates may be subjected to pretreatment, such as chemical treatment with a silane coupling agent, plasma treatment, ion plating, sputtering, gas-phase reaction or vacuum deposition.

Next, the substrate is typically dried at from 60 to 120° C. for 1 to 5 minutes on a hot plate or in an oven. The dried substrate may also be recoated. Recoating after the completion of drying is also possible. Last of all, by carrying out baking at from 200 to 400° C. for 10 to 120 minutes, a highly transparent cured film of the desired thickness (e.g., from 10 to 200 μm) can be obtained.

3. Display Device of the Invention

The display device of the invention includes the curing film of the invention described above. Aside from including the cured film of the invention, the display device of the invention is constructed in the same way as a conventional display device. Illustrative examples of such display devices include liquid-crystal display devices, touch panels, integrated liquid-crystal device/touch panel devices, and integrated display device/touch panel devices having an organic compound-based light emission layer, such as OLED devices.

The display device of the invention also encompasses liquid-crystal devices. Liquid-crystal display devices according to the invention have a construction that includes a color filter, a second transparent substrate (e.g., a TFT substrate) having pixel electrodes and common electrodes which are arranged opposite the color filter, and liquid crystals sandwiched between both substrates. In such a liquid-crystal display device, the cured film may be used as a film that is required to have both transparency and heat resistance. The liquid-crystal display device is fabricated via a step in which a color filter substrate that has been alignment layer treated and the second transparent substrate that has been alignment layer treated are assembled so as to face one another with spacers therebetween, a liquid crystal material sealing step, and a polarized film attachment step. The cured film can be formed within the liquid-crystal display device at a position suitable for the particular application by way of, in any of these manufacturing steps, a coating step that forms an applied film of a suitable thickness and a baking step that bakes the applied film.

The electrodes provided on the substrate in this liquid-crystal display device are formed by using a sputtering process or the like to deposit a metal such as chromium on a clear substrate, then carrying out etching with a resist pattern of a predetermined shape as the mask.

As described above, the heat-curable composition according to preferred embodiments of the invention are capable of forming cured films which have the high solvent resistance, high water, resistance, high acid resistance, high alkali resistance, good adherence to the underlying material, high heat resistance and high transparency that are generally required of cured films formed of polymer compositions, and moreover also have an excellent sputtering resistance.

Moreover, the heat-curable composition according to the preferred embodiments of the invention are able to form a thick film without giving rise to cracks during heat curing.

Accordingly, the heat-curable composition of the invention, particularly when rendered into a cured film having a thickness of at least several tens of micrometers, has an excellent transparency, heat resistance and sputtering resistance, making it suitable for liquid-crystal devices, touch panels, integrated liquid-crystal device/touch panel devices and integrated OLED device/touch panel devices. Moreover, it is suitable, in either a color filter manufacturing operation or a TFT manufacturing operation, for a coating step in which an applied film of a suitable thickness is formed and a baking step in which the applied film is baked.

### EXAMPLES

The invention is further described below by way of examples, although these are not intended to limit the invention in any way.

### Synthesis Example 1

### Synthesis of Siloxane Polymer (A1)

A four-neck flask equipped with a stirrer was charged with diethylene glycol methyl ethyl ether as a reaction solvent, trimethylmethoxysilane as a monofunctional silane of general formula (1), and trimethoxymethylsilane and trimethoxyphenylsilane as trifunctional silanes of general formula (2) in the respective weights indicated below. In addition, a mixed solvent of 0.19 g of formic acid, 0.08 g of phosphoric acid and 5.81 g of water was added dropwise. Next, the flask contents were heated at 80° C. for 1 hour, then low-molecular-weight components were removed by 2.5 hours of distillation, in addition to which the contents were distilled at 130° C. for 2 hours, thereby giving an 80 wt % solution of Siloxane Polymer (A1). The total amount of low-boiling components removed by distillation was 21.07 g.

| | |
|---|---|
| Diethylene glycol methyl ethyl ether | 4.91 g |
| Trimethylmethoxysilane | 1.84 g |
| Trimethoxymethylsilane | 6.90 g |
| Trimethoxyphenylsilane | 10.0 g |

The solution was cooled to room temperature (25° C.), following which a sample of the solution was collected and the weight-average molecular weight of Siloxane Polymer (A1) was measured by GPC analysis against a polystyrene standard. As a result, the weight-average molecular weight (MW) was 4,300. The ratio of the number of methyl groups to the number of phenyl groups in Siloxane Polymer (A1) was 2.1.

### Synthesis Example 2

### Synthesis of Siloxane Polymer (A2)

Aside from using triethoxymethylsilane instead of trimethoxymethylsilane as a trifunctional silane of general formula (2), the same ingredients as in Synthesis Example 1 were charged in the weights indicated below and reaction was carried out under the same conditions as in Synthesis Example 1, thereby giving a solution having an 80 wt % solution of Siloxane Polymer (A2). According to GPC analysis, the weight-average molecular weight (Mw) of the resulting Siloxane Polymer (A2) was 4,000. The ratio of the number of methyl groups to the number of phenyl groups in Siloxane Polymer (A2) was 2.0.

| | |
|---|---|
| Diethylene glycol methyl ethyl ether | 5.32 g |
| Trimethylmethoxysilane | 1.84 g |
| Triethoxymethylsilane | 8.28 g |
| Trimethoxyphenylsilane | 10.0 g |

### Synthesis Example 3

### Synthesis of Siloxane Polymer (A3)

Aside from using triethoxyphenylsilane instead of trimethoxyphenylsilane as a trifunctional silane of general formula (2), the same ingredients as in Synthesis Example 1 were charged in the weights indicated below and reaction was carried out under the same conditions as in Synthesis Example 1, thereby giving a solution having an 80 wt % solution of Siloxane Polymer (A3). According to GPC analysis, the weight-average molecular weight (Mw) of the resulting Siloxane Polymer (A3) was 3,700. The ratio of the number of methyl groups to the number of phenyl groups in Siloxane Polymer (A3) was 2.0.

| | |
|---|---|
| Diethylene glycol methyl ethyl ether | 5.29 g |
| Trimethylmethoxysilane | 1.84 g |
| Trimethoxymethylsilane | 6.90 g |
| Triethoxyphenylsilane | 12.2 g |

### Synthesis Example 4

### Synthesis of Siloxane Polymer (A4)

Trimethylmethoxysilane, trimethoxymethylsilane and trimethoxyphenylsilane were charged in the weights indicated below and a reaction was carried out under the same conditions as in Synthesis Example 1, thereby giving a 80 wt % solution of Siloxane Polymer (A4). According to GPC analysis, the weight-average molecular weight (Mw) of the resulting Siloxane Polymer (A4) was 4,200. The ratio of the number of methyl groups to the number of phenyl groups in Siloxane Polymer (A4) was 1.7.

| | |
|---|---|
| Diethylene glycol methyl ethyl ether | 4.81 g |
| Trimethylmethoxysilane | 1.72 g |
| Trimethoxymethylsilane | 8.20 g |
| Trimethoxyphenylsilane | 12.0 g |

### Synthesis Example 5

### Synthesis of Siloxane Polymer (A5)

Trimethylmethoxysilane, trimethoxymethylsilane and trimethoxyphenylsilane were charged in the weights indicated below and a reaction was carried out under the same conditions as in Synthesis Example 1, thereby giving a 80 wt % solution of Siloxane Polymer (A5). According to GPC analysis, the weight-average molecular weight (Mw) of the resulting Siloxane Polymer (A5) was 3,200. The ratio of the number of methyl groups to the number of phenyl groups in Siloxane Polymer (A5) was 2.5.

| | |
|---|---|
| Diethylene glycol methyl ethyl ether | 5.10 g |
| Trimethylmethoxysilane | 2.38 g |
| Trimethoxymethylsilane | 7.00 g |
| Trimethoxyphenylsilane | 9.48 g |

### Example 1

### Preparation of Heat-Curable Composition

The 80 wt % solution of Siloxane Polymer (A1) obtained in Synthesis Example 1 (referred to below as Siloxane Polymer (A1)), Byk-342 as the surfactant, and diethylene glycol methyl ethyl ether as the solvent were mixed and dissolved in the weights indicated below, then filtered using a membrane filter (0.5 μm), thereby giving a heat-curable composition. The makeup of the resulting heat-curable composition is shown in Table 1.

| | |
|---|---|
| Siloxane Polymer (A1) | 10.00 g |
| Diethylene glycol methyl ethyl ether | 4.00 g |
| Byk-342 | 0.01 g |

### Examples 2 to 5

### Preparation of Heat-Curable Compositions

The heat-curable compositions of Examples 2 to 5 were obtained by similarly mixing and dissolving the ingredients shown in Table 1. The numbers within parentheses in Table 1 indicate parts by weight. “A1” to “A5” refer respectively to 80 wt % solutions of Siloxane Polymers (A1) to (A5). EDM is an abbreviation for diethylene glycol methyl ethyl ether.

TABLE 1

| | Siloxane polymer (A) | Solvent | Surfactant |
|---|---|---|---|
| Example 1 | A1 | EDM | Byk-342 |
| | (100) | (20) | (0.12) |
| Example 2 | A2 | EDM | Byk-342 |
| | (100) | (20) | (0.12) |
| Example 3 | A3 | EDM | Byk-342 |
| | (100) | (20) | (0.12) |
| Example 4 | A4 | EDM | Byk-342 |
| | (100) | (20) | (0.12) |
| Example 5 | A5 | EDM | Byk-342 |
| | (100) | (20) | (0.12) |

### Comparative Synthesis Example 1

### Synthesis of Comparative Siloxane Polymer (E1)

Diethylene glycol methyl ethyl ether as the polymerization solvent, methylphenyldimethoxysilane as a bifunctional silane and tetraethoxysilane as a tetrafunctional silane were charged in the weights indicated below, and the reaction was carried out under the same conditions as in Synthesis Example 1, thereby giving an 80 wt % solution of Comparative Siloxane Polymer (E1). According to GPC analysis, the weight-average molecular weight (Mw) of the resulting Siloxane Polymer (E1) was 2,900.

| | |
|---|---|
| Diethylene glycol methyl ethyl ether | 8.53 g |
| Methylphenyldimethoxysilane | 12.3 g |
| Tetraethoxysilane | 7.00 g |

### Comparative Synthesis Example 2

### Synthesis of Comparative Siloxane Polymer (E2)

Trimethylmethoxysilane as a monofunctional silane, trimethoxymethylsilane and trimethoxyphenylsilane as trifunctional silanes, methylphenyldimethoxysilane as a bifunctional silane, and tetraethoxysilane as a tetrafunctional silane were charged in the weights indicated below, and the reaction was carried out under the same conditions as in Synthesis Example 1, thereby giving an 80 wt % solution of Comparative Siloxane Polymer (E2). According to GPC analysis, the weight-average molecular weight (Mw) of the resulting Siloxane Polymer (E2) was 9,800.

| | |
|---|---|
| Diethylene glycol methyl ethyl ether | 6.41 g |
| Trimethylmethoxysilane | 0.98 g |
| Trimethoxymethylsilane | 1.50 g |
| Trimethoxyphenylsilane | 5.30 g |
| Methylphenyldimethoxysilane | 4.08 g |
| Tetraethoxysilane | 3.50 g |

### Comparative Synthesis Example 3

### Synthesis of Comparative Siloxane Polymer (E3)

Trimethylethoxysilane as a monofunctional silane and triethoxymethylsilane as a trifunctional silane were charged in the weights indicated below, in addition to which a mixed solution of 0.04 g of hydrochloric acid and 9.00 g of water was added dropwise. Next, the flask contents were heated at 80° C. for 4 hours, and then low-molecular-weight components were driven off by 2.5 hours of distillation, in addition to which the contents were distilled at 130° C. for 2 hours, thereby giving an 80 wt % solution of Siloxane Polymer (A3). According to GPC analysis, the weight-average molecular weight (Mw) of the resulting Siloxane Polymer (E3) was 12,500.

| | |
|---|---|
| Diethylene glycol methyl ethyl ether | 11.0 g |
| Trimethylethoxysilane | 4.0 g |
| Triethoxymethylsilane | 28.5 g |

### Comparative Synthesis Example 4

### Synthesis of Comparative Siloxane Polymer (E4)

Trimethylmethoxysilane as a monofunctional silane and tetraethoxysilane as a tetrafunctional silane were charged in the weights indicated below, and the reaction was carried out under the same conditions as in Synthesis Example 1.

| | |
|---|---|
| Diethylene glycol methyl ethyl ether | 4.73 g |
| Trimethylmethoxysilane | 1.80 g |
| Tetraethoxysilane | 12.8 g |

The reaction mixture gelled during the reaction, as a result of which the target polymer was not obtained.

### Comparative Synthesis Example 5

### Synthesis of Comparative Siloxane Polymer (E5)

Using trimethylmethoxysilane as a monofunctional silane and methylphenyldimethoxysilane as a bifunctional silane, the reaction was carried out under the same conditions as in Synthesis Example 1, thereby giving an 80 wt % solution of Comparative Siloxane Polymer (E5).

| | |
|---|---|
| Diethylene glycol methyl ethyl ether | 5.92 g |
| Trimethylethoxysilane | 1.80 g |
| Methylphenyldimethoxysilane | 11.0 g |

The Siloxane Polymer (E5) thus obtained was subjected to GPC analysis, but a peak was not detected.

### Comparative Synthesis Example 6

### Synthesis of Comparative Siloxane Polymer (E6)

Using trimethylmethoxysilane as a monofunctional silane, the reaction was carried out under the same conditions as in Synthesis Example 1, thereby giving an 80 wt %, solution of Comparative Siloxane Polymer (E6).

| | |
|---|---|
| Diethylene glycol methyl ethyl ether | 5.92 g |
| Trimethylethoxysilane | 12.8 g |

The Siloxane Polymer (E6) thus obtained was subjected to GPC analysis, but a peak was not detected.

### Comparative Synthesis Example 7

### Synthesis of Comparative Siloxane Polymer (E7)

Using trimethoxymethylsilane and trimethoxyphenylsilane as trifunctional silanes, the reaction was carried out under the same conditions as in Synthesis Example 1.

| | |
|---|---|
| Diethylene glycol methyl ethyl ether | 12.5 g |
| Trimethoxymethylsilane | 9.40 g |
| Trimethoxyphenylsilane | 13.7 g |

The reaction mixture gelled during the reaction, as a result of which the target polymer was not obtained.

### Comparative Examples 1 to 7

### Preparation of Heat-Curable Compositions

The heat-curable compositions of Comparative Examples 1 to 5 were obtained in the same way as in Examples 1 to 5 from the siloxane polymer solutions obtained in Synthesis Example 1 and Comparative Synthesis Examples 1 to 3. The numbers within parentheses in Table 2 indicate parts by weight, “A1” refers to an 80 wt % solution of Siloxane Polymer (A1), and “E1” to “E3” refer respectively to 80 wt % solutions of Siloxane Polymers (E1) to (E3). EDM is an abbreviation for diethylene glycol methyl ethyl ether. In Comparative Synthesis Examples 4 to 7, solutions of comparative siloxane polymers could not be obtained, and so heat-curable compositions were not created.

TABLE 2

| | Siloxane | | | |
|---|---|---|---|---|
| | polymer (A) | Siloxane polymer (E) | Solvent | Surfactant |
| Comp. Ex. 1 | — | E1 | EDM | Byk-342 |
| | | (100) | (20) | (0.12) |
| Comp. Ex. 2 | — | E2 | EDM | Byk-342 |
| | | (100) | (20) | (0.12) |
| Comp. Ex. 3 | — | E3 | EDM | Byk-342 |
| | | (100) | (20) | (0.12) |
| Comp. Ex. 4 | A1 | E1 | EDM | Byk-342 |
| | (50) | (50) | (20) | (0.12) |
| Comp. Ex. 5 | A1 | E1 | EDM | Byk-342 |
| | (80) | (20) | (20) | (0.12) |

Evaluation Methods

### 1) Formation of Transparent Film

The heat-curable composition was spin-coated for 10 seconds at any speed from 400 to 1,000 rpm, or was screen-printed, onto a glass substrate to form a solid film, and then was pre-baked and dried for 5 minutes on a 100° C. hot plate. In addition, the substrate was post-baked for 30 minutes in an oven at 300° C., thereby forming a transparent film having a thickness of about 20 μm. The substrate was removed from the oven and allowed to return to room temperature, following which the thickness of the resulting transparent film was measured. A P-15 stylus-based profiler available from KLA-Tencor Japan was used to measure the film thickness. The average of measurements taken at three places on the film was treated as the thickness of the transparent film.

2) Coating Properties

During creation of the transparent film in 1) above by spin coating or screen printing, the coating properties (i.e., whether substrate repels composition, referred to below as “cissing”) during prebake drying were visually examined. In cases where cissing or pinholes were not observed, the coating properties were rated as “G” (Good). In cases where cissing and pinholes were observed, the coating properties were rated as “NG” (No Good).

3) Cracking Resistance

The transparent films obtained by spin coating or screen printing in 1) were visually examined for the presence or absence of cracking. In cases where cracks did not form on the film surface, this was rated as “G” (Good). In cases where cracks formed on the film surface, this was rated as “NG” (No Good).

4) Surface Roughness

The surface roughness (Ra value) of the spin-coated transparent film obtained in 1) above was measured. In cases where the Ra value was less than 2 nm, the surface roughness was rated as “G” (Good). In cases where the Ra value was 2 nm or more, the surface roughness was rated as “NG” (No Good). Measurement was carried out using a P-15 stylus-based profiler available from KLA-Tencor Japan. The average of measurements taken at three places on the film was treated as the surface roughness of the transparent film.

5) Transparency

The light transmittance at a wavelength of 400 nm of the substrate on which a transparent film had been formed by spin coating in 1) above was measured using a V-670 UV-visible-near infrared spectrophotometer from JASCO Corporation and using as the reference a glass substrate on which a transparent film had not been formed. When the transmittance was 95% T or more, the transparency was rate as “G” (Good). When the transmittance was less than 95% T, the transparency was rated as “NG” (No Good).

6) Acid Resistance

The substrate on which a transparent film had been formed by spin coating in 1) above was immersed for 10 minutes in a 50° C. hydrochloric acid/nitric acid/water=4/2/4 (weight ratio) mixture, and the change in film thickness was measured. The film thickness was measured in the same way as in 1) above, both before and after immersion, and the acid resistance was calculated from the following formula.

(Film thickness after immersion/Film thickness before immersion)×100(%)

In cases where the percent change in film thickness was from −5% to 5%, the acid resistance was rated as “G” (Good). In cases where the percent change in film thickness exceeded 5% due to swelling or fell below −5% due to dissolution, the acid resistance was rated as “NG” (No Good).

7) Alkali Resistance

The substrate on which a transparent film had been formed by spin coating in 1) above was immersed for 10 minutes in 5% aqueous sodium hydroxide at 60° C., and the change in film thickness was measured. The film thickness was measured in the same way as in 1) above, both before and after immersion, and the alkali resistance was calculated from the following formula.

(Film thickness after immersion/Film thickness before immersion)×100(%)

In cases where the percent change in film thickness was from −5% to 5%, the alkali resistance was rated as “G” (Good). In cases where the percent change in film thickness exceeded 5% due to swelling or fell below −5% due to dissolution, the alkali resistance was rated as “NG” (No Good).

8) Heat Resistance

The substrate on which a transparent film had been formed by spin coating in 1) above was heated 1 hour in a 300° C. oven, and the light transmittance was measured in the same way as in 5) above. The film thickness was measured in the same way as in 1) above, both before and after heating, and the heat resistance was calculated from the following formula.

(Film thickness after immersion/Film thickness before immersion)×100(%)

In cases where the percent change in film thickness was smaller than −5%, the alkali resistance was rated as “G” (Good). In cases where the change in film thickness after heating was −5% or larger, the heat resistance was rated as “NG” (No Good).

9) Sputtering Resistance

The film surface state when ITO was sputtered onto the transparent film formed by spin coating in 1) above was visually examined. In cases where cracks did not form on the film surface, the sputtering resistance was rated as “G” (Good). In cases where cracks formed on the film surface, the sputtering resistance was rated as “NG” (No Good).

The results obtained by the above evaluation methods for the heat-curable compositions of Examples 1 to 5 are shown in Table 3.

TABLE 3

| | | Coating properties | | Cracking resistance | | | | | | | |
|---|---|---|---|---|---|---|---|---|---|---|---|
| | Film | Spin | Screen | Spin | Screen | Surface | | Acid | Alkali | Heat | Sputtering |
| Example | thickness | coating | printing | coating | printing | roughness | Transparency | resistance | resistance | resistance | resistance |
| 1 | 22.3 | G | G | G | G | G | G | G | G | G | G |
| 2 | 21.7 | G | G | G | G | G | G | G | G | G | G |
| 3 | 22.0 | G | G | G | G | G | G | G | G | G | G |
| 4 | 21.5 | G | G | G | G | G | G | G | G | G | G |
| 5 | 21.4 | G | G | G | G | G | G | G | G | G | G |

(The units of film thickness are mm.)

The results obtained by the above methods of evaluation for the heat-curable polymer compositions of Comparative Examples 1 to 5 are shown in Table 4.

TABLE 4

| | | Coating properties | | Cracking resistance | | | | | | | |
|---|---|---|---|---|---|---|---|---|---|---|---|
| Comparative | Film | Spin | Screen | Spin | Screen | Surface | | Acid | Alkali | Heat | Sputtering |
| Example | thickness | coating | printing | coating | printing | roughness | Transparency | resistance | resistance | resistance | resistance |
| 1 | 22.3 | G | G | G | G | G | G | G | G | G | NG |
| 2 | 21.7 | NG | NG | G | G | NG | G | G | G | G | NG |
| 3 | 18.2 | G | G | NG | NG | NG | G | G | G | G | NG |
| 4 | 22.0 | G | G | G | G | G | G | G | G | G | NG |
| 5 | 21.5 | G | G | G | G | G | G | G | G | G | NG |

(The units of film thickness are μm.)

Additional Evaluations of Heat Resistance

### Synthesis Example 6

### Synthesis of Siloxane Polymer (A6)

Aside from using 2.6 g of trimethylmethoxysilane as a monofunctional silane of general formula (1) and 20.0 g of trimethoxyphenylsilane as a trifunctional silane of general formula (2), the same ingredients as in Synthesis Example 1 were charged in the weights indicated below and the reaction was carried out under the same conditions as in Synthesis Example 1, thereby giving a 80 wt % solution of Siloxane Polymer (A6). The ratio of the number of methyl groups to the number of phenyl groups in Siloxane Polymer (A6) was 0.5.

### Synthesis Example 7

### Synthesis of Siloxane Polymer (A7)

Aside from using 2.15 g of trimethylmethoxysilane as a monofunctional silane of general formula (1) and 4.00 g of trimethoxymethylsilane and 17.45 g of trimethoxyphenylsilane as trifunctional silanes of general formula (2), the same ingredients as in Synthesis Example 1 were charged in the weights indicated below and the reaction was carried out under the same conditions as in Synthesis Example 1, thereby giving a 80 wt % solution of Siloxane Polymer (A7). The ratio of the number of methyl groups to the number of phenyl groups in Siloxane Polymer (A7) was 1.0.

### Synthesis Example 8

### Synthesis of Siloxane Polymer (A8)

Aside from using 1.84 g of trimethylmethoxysilane as a monofunctional silane of general formula (1) and 6.90 g of trimethoxymethylsilane and 10.0 g of trimethoxyphenylsilane as trifunctional silanes of general formula (2), the same ingredients as in Synthesis Example 1 were charged in the weights indicated below and the reaction was carried out under the same conditions as in Synthesis Example 1, thereby giving a 80 wt % solution of Siloxane Polymer (A8). The ratio of the number of methyl groups to the number of phenyl groups in Siloxane Polymer (A8) was 2.1.

### Synthesis Example 9

### Synthesis of Siloxane Polymer (A9)

Aside from using 2.00 g of trimethylmethoxysilane as a monofunctional silane of general formula (1) and 5.00 g of trimethoxymethylsilane and 7.30 g of trimethoxyphenylsilane as trifunctional silanes of general formula (2), the same ingredients as in Synthesis Example 1 were charged in the weights indicated below and the reaction was carried out under the same conditions as in Synthesis Example 1, thereby giving a 80 wt % solution of Siloxane Polymer (A9). The ratio of the number of methyl groups to the number of phenyl groups in Siloxane Polymer (A9) was 2.5.

### Examples 6 to 9

### Preparation of Heat-Curable Composition's

The heat-curable compositions of Examples 6 to 9 were obtained by mixing and dissolving the ingredients shown in Table 5 in the same way as in Examples 2 to 5. The numbers within parentheses in Table 5 indicate parts by weight. “A6” to “A9” refer respectively to 80 wt % solutions of Siloxane Polymers (A6) to (A9). EDM is an abbreviation for diethylene glycol methyl ethyl ether.

TABLE 5

| | Siloxane polymer (A) | Solvent | Surfactant |
|---|---|---|---|
| Example 6 | A6 | EDM | Byk-342 |
| | (100) | (20) | (0.12) |
| Example 7 | A7 | EDM | Byk-342 |
| | (100) | (20) | (0.12) |
| Example 8 | A8 | EDM | Byk-342 |
| | (100) | (20) | (0.12) |
| Example 9 | A9 | EDM | Byk-342 |
| | (100) | (20) | (0.12) |

Formation of Transparent Film

The heat-curable composition was spin-coated for 10 seconds at any speed from 400 to 1,000 rpm onto a glass substrate, and then was pre-baked and dried for 5 minutes on a 100° C. hot plate. In addition, the substrate was post-baked for 30 minutes in an oven at 250° C. or 300° C., thereby forming a transparent film having a thickness of about 20 μm. The substrate was removed from the oven and allowed to return to room temperature, following which the thickness of the resulting transparent film was measured. A P-15 stylus-based profiler available from KLA-Tencor Japan was used to measure the film thickness. The average of measurements taken at three places on the film was treated as the thickness of the transparent film.

The transparent film was visually checked to determine whether cracks formed in the film when it cooled to room temperature. Cases in which cracks did not form were rated as “G”; cases in which cracks formed were rated as “NG.”

TABLE 6

| | | | Film thickness |
|---|---|---|---|
| | Cracking (250° C.) | Cracking (300° C.) | (μm) |
| Example 6 | G | NG | 21 |
| Example 7 | G | G | 20 |
| Example 8 | G | G | 19 |
| Example 9 | G | G | 19 |

It is apparent from the results obtained for Examples 6 to 9 that, in cases where the silanes making up Siloxane Polymer (A) contain methyl and phenyl groups, when the ratio of the number of methyl groups to the number of phenyl groups in the Siloxane Polymer (A) produced is 1 or more, the conventional heat resistance (30 minutes at 250° C.) and also the heat resistance at high temperature (30 minutes at 300° C.) were both excellent.

### INDUSTRIAL APPLICABILITY

The heat-curable composition of the invention can be used in manufacturing operations for the production of, e.g., liquid-crystal display devices, touch panels, liquid-crystal display devices with touch panels and OLED display devices with touch panels.

1. A heat-curable composition comprising a siloxane polymer and a solvent, wherein the siloxane polymer includes at least 90 wt %, based on the total amount of siloxane polymer, of a siloxane polymer (A) obtained by reacting a silane mixture containing a monofunctional silane of general formula (1) below and a trifunctional silane of general formula (2) below: 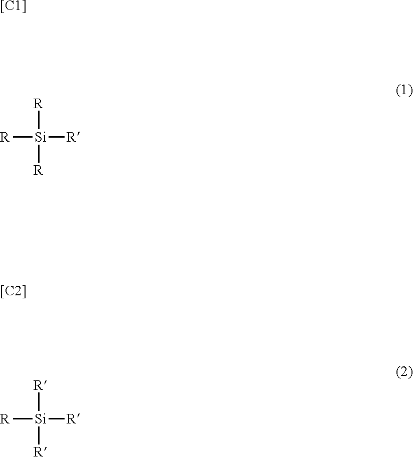
(wherein, in general formulas (1) and (2), R is independently hydrogen, an alkyl of 1 to 10 carbons in which any hydrogen may be substituted with a halogen, an aryl of 6 to 10 carbons in which any hydrogen may be substituted with a halogen, or an alkenyl of 2 to 10 carbons in which any hydrogen may be substituted with a halogen; and R′ is independently a hydrolyzable group), the trifunctional silane of general formula (2) including, in a proportion that is at least 30 mol % of the total amount of trifunctional silane, a trifunctional silane wherein R is an aryl of 6 to 10 carbons in which any hydrogen may be substituted with a halogen.

2. The heat-curable composition according to claim 1, wherein, in general formulas (1) and (2), R is independently hydrogen, an alkyl of 1 to 5 carbons in which any hydrogen may be substituted with a halogen, an aryl of 6 to 10 carbons in which any hydrogen may be substituted with a halogen, or an alkenyl of 2 to 10 carbons in which any hydrogen may be substituted with a halogen; and R′ is independently an alkoxy, a halogen or acetoxyl.

3. The heat-curable composition according to claim 1, wherein the monofunctional silane of general formula (1) is one or more selected from the group consisting of trimethylmethoxysilane and trimethylethoxysilane.

4. The heat-curable composition according to claim 1, wherein the trifunctional silane of general formula (2) is a mixture of one or more selected from among trimethoxyphenylsilane and triethoxyphenylsilane with one or more selected from among trimethoxymethylsilane and triethoxymethylsilane.

5. The heat-curable composition according to claim 1, wherein the monofunctional silane of general formula (1) is trimethylmethoxysilane and the trifunctional silane of general formula (2) is a mixture of trimethoxymethylsilane and trimethoxyphenylsilane.

6. The heat-curable composition according to claim 5, wherein the siloxane polymer (A) has a ratio of the number of methyl groups to the number of phenyl groups therein of from 1.0 to 3.0.

7. A cured film having a thickness of from 10 to 200 μm obtained by heat-curing the heat-curable composition according to claim 1, at 200° C. or above.

8. A display device comprising the cured film according to claim 7.

9. The heat-curable composition according to claim 2, wherein the monofunctional silane of general formula (1) is one or more selected from the group consisting of trimethylmethoxysilane and trimethylethoxysilane.

10. The heat-curable composition according to claim 2, wherein the trifunctional silane of general formula (2) is a mixture of one or more selected from among trimethoxyphenylsilane and triethoxyphenylsilane with one or more selected from among trimethoxymethylsilane and triethoxymethylsilane.

11. The heat-curable composition according to claim 3, wherein the trifunctional silane of general formula (2) is a mixture of one or more selected from among trimethoxyphenylsilane and triethoxyphenylsilane with one or more selected from among trimethoxymethylsilane and triethoxymethylsilane.

12. The heat-curable composition according to claim 2, wherein the monofunctional silane of general formula (1) is trimethylmethoxysilane and the trifunctional silane of general formula (2) is a mixture of trimethoxymethylsilane and trimethoxyphenylsilane.

13. The heat-curable composition according to claim 3, wherein the monofunctional silane of general formula (1) is trimethylmethoxysilane and the trifunctional silane of general formula (2) is a mixture of trimethoxymethylsilane and trimethoxyphenylsilane.

14. The heat-curable composition according to claim 4, wherein the monofunctional silane of general formula (1) is trimethylmethoxysilane and the trifunctional silane of general formula (2) is a mixture of trimethoxymethylsilane and trimethoxyphenylsilane.

15. A cured film having a thickness of from 10 to 200 μm obtained by heat-curing the heat-curable composition according to claim 2, at 200° C. or above.

16. A cured film having a thickness of from 10 to 200 μm obtained by heat-curing the heat-curable composition according to claim 3, at 200° C. or above.

17. A cured film having a thickness of from 10 to 200 μm obtained by heat-curing the heat-curable composition according to claim 4, at 200° C. or above.

18. A cured film having a thickness of from 10 to 200 μm obtained by heat-curing the heat-curable composition according to claim 5, at 200° C. or above.

19. A cured film having a thickness of from 10 to 200 μm obtained by heat-curing the heat-curable composition according to claim 6, at 200° C. or above.
